(19) United States
(12) Patent Application Publication
(10) Pub. No.: US 2017/0085475 A1
(43) Pub. Date: Mar. 23, 2017

(54) CONFIGURABLE AND SCALABLE BUS INTERCONNECT FOR MULTI-CORE, MULTI-THREADED WIRELESS BASEBAND MODEM ARCHITECTURE

(71) Applicant: QUALCOMM Incorporated, San Diego, CA (US)

(72) Inventors: Scott Wang-Yip Cheng, Foothill Ranch, CA (US); Raheel Khan, Tustin, CA (US); Vijay Bantval, San Diego, CA (US); Jun Ho Bahn, San Diego, CA (US)

(21) Appl. No.: 15/080,429

(22) Filed: Mar. 24, 2016

Related U.S. Application Data
(60) Provisional application No. 62/222,725, filed on Sep. 23, 2015.

(51) Int. Cl. H04L 12/741; H04L 12/413; H04L 1/00; H04L 12/46; H04L 12/733

(52) U.S. Cl. CPC H04L 45/74; H04L 12/4637; H04L 45/20; H04L 1/0018; H04L 12/4135

(57) ABSTRACT

Various aspects of this disclosure describe a bi-directional, dual interconnect bus configured in a ring to route data to processors implementing modem functions. A plurality of nodes may be coupled to form a ring bus comprising at least two interconnect rings. A plurality of processors may be assigned to the plurality of nodes. A first processor among the plurality of processors may be configured to process a first data type, and a second processor among the plurality of processors may be configured to process a second data type. Data on the ring bus may be separated into the first data type and the second data type, and separated data of the first data type may be routed on one interconnect ring to the first processor and separated data of the second data type may be routed on another interconnect ring to the second processor.

### RELATED APPLICATIONS

This application claims priority to U.S. Provisional Patent Application No. 62/222,725, filed Sep. 23, 2015, the disclosure of which is incorporated by reference herein in its entirety.

### BACKGROUND

### Field of the Disclosure

The present disclosure relates to the operation of a modulator, demodulator, or modem to process a data stream using multiple processors with a distributed memory architecture, and more particularly to a dual, bi-directional interconnect ring bus.

### Description of Related Art

Computing devices often contain modems to enable communications with other computing devices. Modems are typically configured to perform both transmitter and receiver operations and as such may be used in two-way communications devices, such as mobile phones. Because a modem may operate on data which occupies various spectra throughout its processing chain, it is common for a modem to be implemented as a chipset rather than on a single chip. For example, frequency translation and radio frequency/intermediate frequency (RF/IF) processing may be done on one chip (or die), which is then coupled to a second chip (or die) performing baseband functions, such as modulation/demodulation and encoding/decoding.

Baseband processing may be implemented in a variety of ways, such as through use of dedicated logic, processors, or combinations thereof. For example, it is not unusual for modern modems to contain up to 30 processors to implement baseband processing in a distributed memory architecture connected with a system bus. A system bus may comprise multiple busses, such as a control bus, address bus, and data bus, and may connect components in a variety of ways, such as ad hoc, with a cross-bar type bus, mesh, point-to-point protocol, or in a ring. Data congestion on a bus can vary depending on how components are connected on the bus, how data is routed, and data arbitration scheme employed. For example, a centralized arbitration scheme operating on all components connected to a bus may induce undesirable latency that adds to data congestion on the bus. Furthermore, each processor may have fast access to its own local memory, but may also be required to access memory of another processor, which may exacerbate data congestion. In addition, some bus architectures are not amenable to scalability in number of processors, and often need to be redesigned and laid out to accommodate additional processors that may be added to a modem to support additional modem features.

### SUMMARY

This Summary is provided to introduce a selection of concepts in a simplified form that are further described below in the Detailed Description. This Summary is not intended to identify key features or essential features of the claimed subject matter.

In some aspects, a device for processing signals comprises a plurality of nodes. Each node among the plurality of nodes has an address, and each of the addresses is different. The device also comprises a plurality of processors. Each of the plurality of processors is uniquely assigned to a node among the plurality of nodes. The device also comprises a dual interconnect bus that is comprised of a first ring bus and a second ring bus that connect the plurality of nodes in a ring. The first ring bus and the second ring bus may be configured for different data structures. The dual interconnect bus is configured to route data on at least one of the first ring bus or the second ring bus to at least one node among the plurality of nodes according to an address assigned to the at least one node. The data is processed by a processor among the plurality of processors assigned to the at least one node.

In other aspects, a method for routing data on a bus couples a plurality of nodes. Each node among the plurality of nodes is coupled to a first neighboring node in a first direction and a second neighboring node in a second direction to form a ring bus comprising at least two interconnect rings. A plurality of processors is assigned to the plurality of nodes. A first processor among the plurality of processors is configured to process a first data type, and a second processor among the plurality of processors is configured to process a second data type. Data on the ring bus is separated into the first data type and the second data type. At least part of the separated data of the first data type is routed on one interconnect ring to the first processor and at least part of the separated data of the second data type is routed on another interconnect ring to the second processor.

In yet other aspects, an apparatus for processing signals comprises a plurality of nodes. Each node among the plurality of nodes has an address where each of the addresses is different. The apparatus also comprises a plurality of processors and a ring bus having at least two interconnect rings. The apparatus also comprises means for, based on the addresses, assigning the plurality of processors to the plurality of nodes. A first processor among the plurality of processors is configured to process a first data structure, and a second processor among the plurality of processors is configured to process a second data structure. The apparatus also comprises means for, based on the addresses, coupling the plurality of nodes with the ring bus. Each node among the plurality of nodes is coupled to a first neighboring node in a first direction and a second neighboring node in a second direction. The apparatus also comprises means for, based on the first data structure and the second data structure, separating data on the ring. The apparatus also comprises means for, based on the separated data, routing at least part of the separated data on one interconnect ring to the first processor and at least another part of the separated data on another interconnect ring to the second processor.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 illustrates an example modem device in accordance with one or more aspects.

FIG. 2 illustrates an example modem implementation architecture in accordance with one or more aspects.

FIG. 3 illustrates an example interconnect node in accordance with one or more aspects.

FIG. 4 illustrates an example clock distribution in accordance with one or more aspects.

FIG. 5 illustrates an example method for implementing a dual, bi-directional interconnect ring in accordance with one or more aspects.

FIG. 6 illustrates an example method for implementing a dual, bi-directional interconnect ring in accordance with one or more aspects.

FIG. 7 illustrates a system-on-chip (SoC) having components through which aspects of a dual, bi-directional interconnect ring can be implemented in accordance with one or more aspects.

### DETAILED DESCRIPTION

Modems often implement transmitters and receivers using processors and other signal-processing circuits. This disclosure describes a bi-directional, dual interconnect bus configured in a ring to route data to processors and signal-processing circuits implementing modem functions. Data may be separated according to data type and routed on a ring suitable to the data type. Arbitration may be done locally at nodes connecting the processors and the other signal-processing circuits to the interconnect ring bus. As such, the dual interconnect ring bus is highly scalable, being able to support any number of nodes and processors, yet with distributed memory support. The dual interconnect ring bus is also highly configurable as it is able to support various layout configurations. It can also enable low congestion, because in the ring structure each node is connected to its adjacent nodes, which reduces routing congestion. The dual interconnect ring bus may also be quick time-to-market, since various tiers of modems can be supported without redesign.

In the following discussion, an example modem, techniques that elements of the example modem may implement, and a system-on-chip on which elements of the example modem may be employed, are described. Consequently, performance of the example procedures is not limited to the example modem and the example modem is not limited to performance of the example procedures. Any reference made with respect to the example modem, or elements thereof, is by way of example only and is not intended to limit any of the aspects described herein.

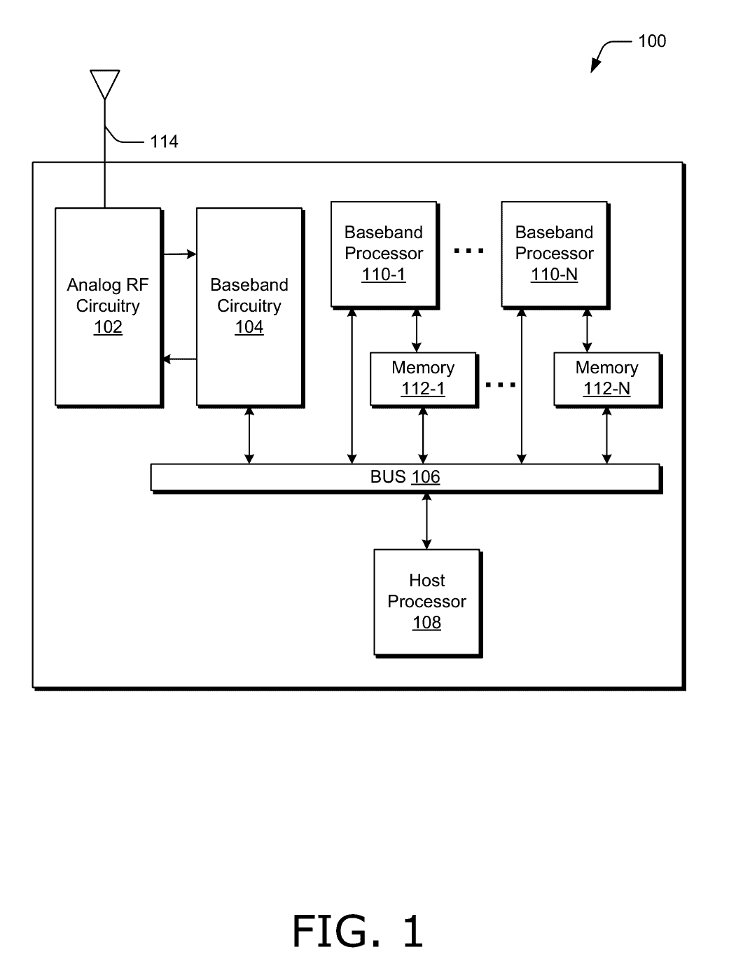

FIG. 1 illustrates an example modem 100 in accordance with one or more aspects of the disclosure. Modem 100 may comprise any suitable type of computing device, such as a cellular phone, tablet, laptop computer, set-top box, satellite receiver, cable television receiver, access point, desktop computer, gaming device, vehicle navigation system, cell tower, modem, cable head-end, and the like. As illustrated, modem 100 includes analog Radio Frequency (RF) circuitry 102, baseband (BB) circuitry 104, bus 106, host processor 108, BB processors 110-1-110-N, and memories 112-1-112-N. For simplicity's sake, the discussion of modem 100 is reserved to these modules. However, various embodiments can include additional components, hardware, software and/or firmware without departing from the scope of the subject matter described herein. Modem 100 may be implemented on multiple chips, multiple die, or on a single chip. A single chip may contain a single die, or multiple dies. In some embodiments, analog RF circuitry 102 is implemented on a first chip, baseband circuitry 104 on a second chip, and so forth. At times, chips may be interconnected with one another using SERializer/DESerializer (SERDES) functions.

In some embodiments, modem 100 performs frequency translation, encoding/decoding, and/or modulation/demodulation to process data sent over a communication link between a user device, such as a cell phone, and a cell tower/towers. Frequency translation, encoding/decoding, and/or modulation/demodulation may be in accordance with a signal protocol, such as a 3^{rd} Generation Partnership Project (3GPP) protocol, a Long Term Evolution (LTE) protocol, and so forth. Modem 100 may be configurable to process signals in accordance with a first signal protocol when modem 100 is in a first configuration, and process signals in accordance with a second signal protocol when modem 100 is in a second configuration. For example, data processed by modem 100 can include signals comprising a first signal that complies with a first regulatory standard and a second signal that complies with a second regulatory standard, such as a first signal complying with a cellular phone standard in a first modem configuration, and a second signal complying with a Wi-Fi standard in a second modem configuration.

Analog RF circuitry 102 sends and receives data over a wireless communication link via one or more antenna, such as antenna 114. Antenna 114 may comprise a single antenna or a plurality of antennas. Alternately or additionally, analog RF circuitry 102 sends and receives data with baseband circuitry 104, such as over a data line. Among other things, analog RF circuitry 102 receives RF data, translates the data to baseband (or near baseband), such as part of a demodulation process, and forwards the baseband data to baseband circuitry 104. Analog RF circuitry 102 can also receive baseband data from baseband circuitry 104, translate the baseband data to RF, such as part of a modulation process, and transmit the modulated data via antenna 114. Frequency translation includes an up-conversion or down-conversion and may be done in a single conversion, or a plurality of conversion steps. For example, translation from an RF signal to a baseband signal may or may not include a translation to an intermediate frequency (IF). Analog RF circuitry 102 may also perform filtering, gain control, DC removal, and/or other compensations. Furthermore, it is to be understood that though modem 100 is illustrated in FIG. 1 as configured for wireless communications using antenna 114, modem 100 can also be configured for wired communications, such as with a cable or twisted pair cable, and/or combinations of wireless and wired communications.

Baseband circuitry 104 implements real-time baseband processing, such as transmitter functions and/or receiver functions, including mapping/de-mapping, cyclic prefix insertion/removal, encoding/decoding, inverse transforms/transforms, and the like. In some embodiments, baseband circuitry 104 includes dedicated hardware logic gates to perform various signal processing and/or real-time signal processing, and can be dynamically programmed using register settings. Baseband circuitry 104 may include a processor and be coupled to bus 106 as a way to communicate with and/or access host processor 108, baseband processors 110-1-110-N, and/or memories 112-1-112-N.

Host processor 108 provides command and control signals to various blocks contained within modem 100, such as analog RF circuitry 102, baseband circuitry 104, and/or baseband processors 110-1-110-N over bus 106. Host processor 108 can be any suitable type of processor, and have any suitable type of configuration. At times, host processor 108 includes a CODEC, video processor, media processor, address manager, and the like.

Baseband processors 110-1-110-N represent programmable processors configured to execute code to perform functions, such as frequency translation, data encoding, data decoding, data modulation, data demodulation, and so forth. Baseband processors 110-1-110-N can be any suitable type of processor, such as scalar processors, vector processors, or a combination thereof. Generally speaking, scalar processors utilize a low-bandwidth, narrow data-width bus for interrupts, data and message passing, while vector processors utilize a high-bandwidth, wide data-width bus to move large amounts of computation data. A processor may be configured to process both scalar data and vector data, or only scalar data or vector data. Furthermore, baseband processors 110-1-110-N are each coupled to, or have, respective memories 112-1-112-N. Thus, memories 112-1-112-N store code to be executed by respective baseband processors 110-1-110-N. Memories 112-1-112-N may comprise cache, flash, DRAM, SRAM, volatile and/or non-volatile memory, and/or any other type of suitable memory, such as computer-readable storage media (CRM) including any suitable type of data storage media, such as optical media (e.g., disc), magnetic media (e.g., disk or tape), and the like.

Blocks comprising modem 100, such as analog RF circuitry 102, baseband circuitry 104, baseband processors 110-1-110-N, memories 112-1-112-N, and host processor 108, may each be assigned an address so they may be identifiable on bus 106. Furthermore, a baseband processor may read/write from/to a memory coupled to the baseband processor, as well as a memory coupled to bus 106. For example, baseband processor 110-1 may read/write from/to any one of memories 112-1-112-N. Bus 106 may comprise multiple busses, such as a control bus, address bus, and data bus, and may connect components in a variety of ways, such as ad hoc, with a cross-bar type bus, mesh, point-to-point protocol, or in a ring. Data congestion on bus 106 can vary depending on how components are connected on the bus, how data is routed, and data arbitration scheme employed.

Having described an example modem device in which various embodiments can be utilized, consider now a discussion of implementing a modem using a dual interconnect ring bus in accordance with one or more embodiments.

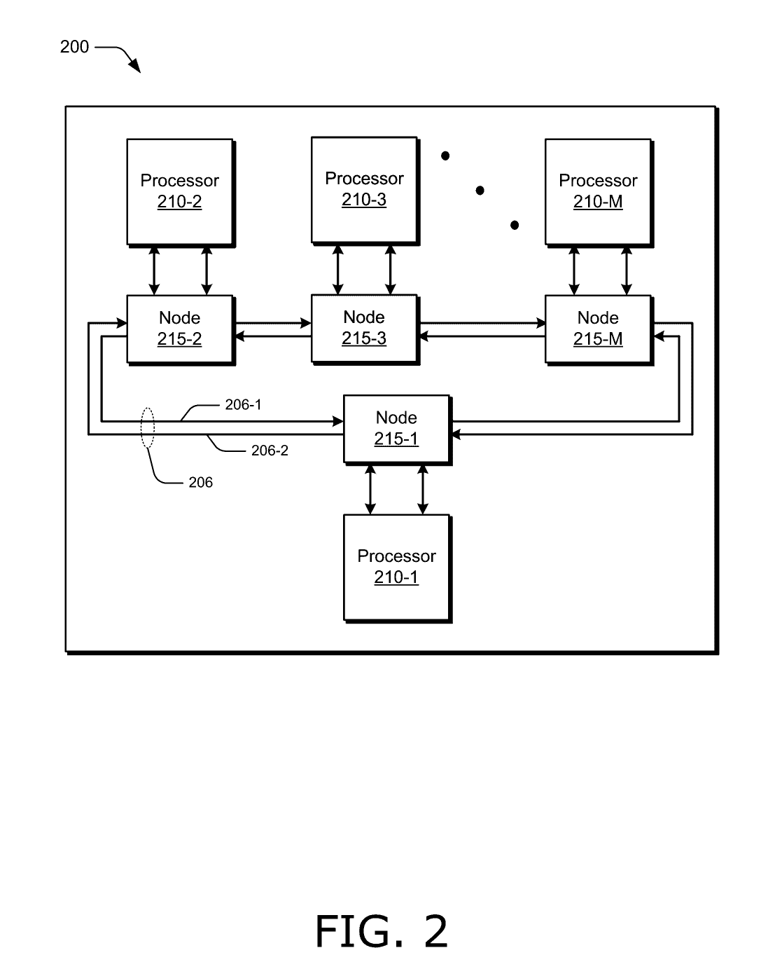

FIG. 2 illustrates example modem implementation 200. For example, modem implementation 200 may implement, at least in part, modem 100 illustrated in FIG. 1. Modem implementation 200 comprises processors 210-1-210-M paired with nodes 215-1-215-M that are connected via bus 206 comprising interconnect ring busses 206-1 and 206-2. Processors 210-1-210-M may comprise any suitable type of processor, such as any processor comprising baseband processors 110-1-110-N and/or host processor 108 in FIG. 1. In addition, processors 210-1-210-M are not limited to programmable micro-processors, digital signal processors, and the like, and as such may include any suitable circuitry for signal processing that can be connected to bus 206. For example, processors 210-1-210-M may include baseband circuitry 104 in FIG. 1. Furthermore, processors 210-1-210-M may each be associated with a local memory, such as any memory comprising memories 112-1-112-N in FIG. 1.

Bus 206 contains a plurality of interconnect ring busses connecting nodes 215-1-215-M in a ring to send and receive data transactions between different processors. Bus 206 may implement bus 106 in FIG. 1. Bus 206 in FIG. 2 is illustrated as comprising two interconnect ring busses, 206-1 and 206-2. Interconnect ring bus 206-1 routes data in a counter-clockwise direction, and interconnect ring bus 206-2 routes data in a clockwise direction in the figure. Alternatively, interconnect ring bus 206-1 may route data in a clockwise direction, and interconnect ring bus 206-2 may route data in a counter-clockwise direction. Thus, bus 206 may be referred to as a dual interconnect ring bus, because it may contain two or more interconnect busses each comprising a ring, i.e., interconnect ring busses. Though FIG. 2 illustrates bus 206 containing two interconnect ring busses, bus 206 may contain any number of interconnect ring busses. Furthermore, interconnect ring busses comprising bus 206 may each be configurable to route data in a clockwise or counter-clockwise direction, so that a number of interconnect ring busses comprising bus 206 route data in one direction, such as clockwise, while the remaining interconnect ring busses comprising bus 206 route data in another direction, such as counter-clockwise. Alternatively, all interconnect ring busses may route data in a same direction.

Interconnect ring busses 206-1 and 206-2 may be configured to route different data types, data structures, data widths, data rates, data packet lengths, and/or data formats. For example, interconnect ring bus 206-1 may be configured to route data packetized in a first packet structure and communicated at a first data rate, and interconnect ring bus 206-2 may be configured to route data packetized in a second packet structure and communicated at a second data rate. In an embodiment, interconnect ring bus 206-1 is configured to route scalar data, and interconnect ring bus 206-2 is configured to route vector data. Additionally, interconnect ring busses 206-1 and 206-2 may support different data widths and different address widths, one to another. Alternatively, interconnect ring busses 206-1 and 206-2 may support a same data width and a same address width, one to another. In an embodiment, interconnect ring busses 206-1 and 206-2 each include a 24-bit address, 32-bit data bus. That is, each interconnect ring bus can transfer up to 32-bit data at up to a 24-bit address. In an implementation, interconnect ring busses 206-1 and 206-2 are configured to route a same data structure, including data width, data format, data packet structure, and/or data rate.

Data of different data types, data structures, data widths, data rates, data packet lengths, and/or data formats can be separated and placed onto different interconnect ring busses comprising bus 206 based on a determined data type, data structure, data width, data rate, data packet length, and/or data format. By separating data onto different interconnect ring busses, data congestion on bus 206 can be reduced.

Processors 210-1-210-M are connected to interconnect ring busses 206-1 and 206-2 through nodes 215-1-215-M, which are each assigned a unique ID. Each processor among processors 210-1-210-M is shown connected to interconnect ring busses 206-1 and 206-2 through a node among nodes 215-1-215-M, so that there is a one-to-one correspondence between processors and nodes. That is, each processor may be paired with a unique node. This implementation is illustrated in FIG. 2 as processors 210-1-210-M are connected to nodes 215-1-215-M in a one-to-one fashion.

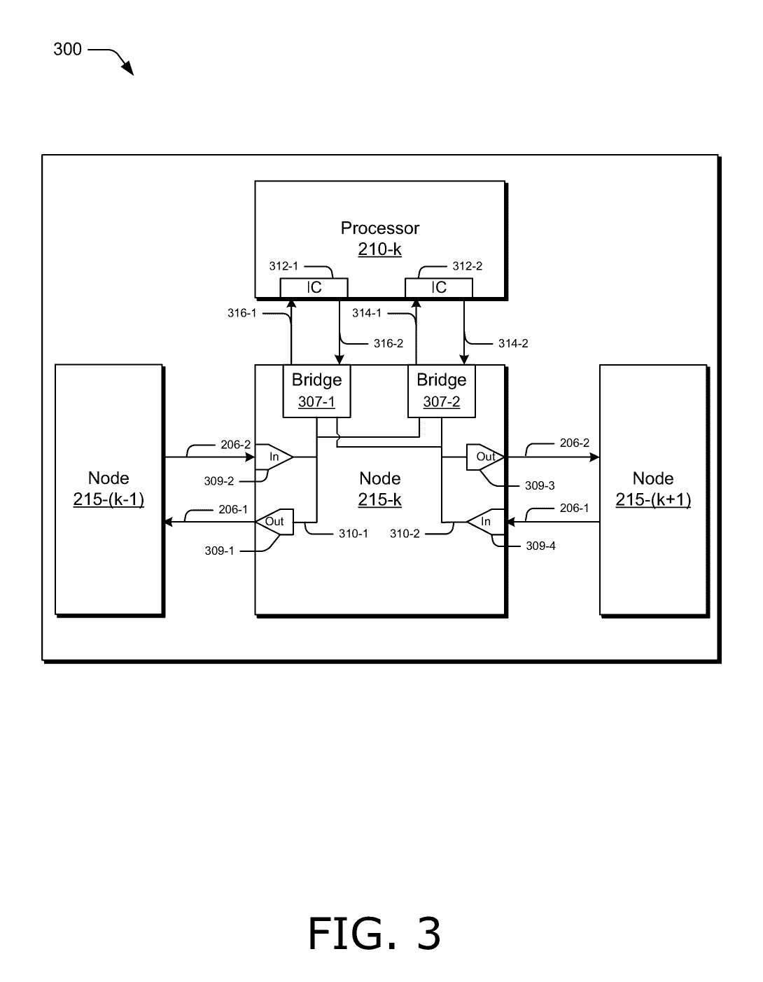

Furthermore, each node among nodes 215-1-215-M are connected to two neighboring nodes using bus 206. FIG. 3 shows environment 300 where node 215-k is connected to nodes 215-(k−1) and 215-(k+1) using interconnect ring busses 206-1 and 206-2. Here, “k” may be any integer, such as an integer between 1 and M. For example, node 215-k in FIG. 3 may be any one of nodes 215-1-215-M in FIG. 2, with node 215-1 and node 215-M being neighbors, and nodes 215-(k−1) and 215-(k+1) are neighboring nodes to node 215-k. Node 215-k comprises input/output (I/O) ports 309-1-309-4 and bridges 307-1-307-2. I/O ports 309-1-309-4 are connected to interconnect ring busses 206-1 and 206-2 so that an input (output) port of one node is coupled to an output (input) node of a neighboring node with data on one of interconnect ring busses 206-1 and 206-2 routed in an opposite direction of the other of interconnect ring busses 206-1 and 206-2. In some embodiments, one of interconnect ring busses 206-1 and 206-2 routes data clockwise and the other of interconnect ring busses 206-1 and 206-2 routes data counter-clockwise. In some embodiments more than two interconnect busses are used, and some interconnect busses route data in a first direction, such as clockwise, while other interconnect busses route data in a second direction, such as counter-clockwise.

Multiple transactions may be concurrently on interconnect ring busses 206-1 and 206-2. In some implementations, traffic is routed in a direction on interconnect ring busses 206-1 and/or 206-2 according to a shortest direction. For example, if a first processor requests a transaction with a second processor, a direction is selected according to a minimum number of node hops between a counter-clockwise and clockwise traverse of interconnect ring busses 206-1 and/or 206-2 from the node assigned to the first processor to the node assigned to the second processor. A node may be identified on interconnect ring busses 206-1 and/or 206-2 using unique node ID's assigned to each node.

Each node among nodes 215-1-215-M, such as node 215-k in FIG. 3, may perform local arbitration. For example, a distributed bus arbitration scheme may be deployed at each node based on an available token and/or transaction ID. A token or transaction ID is assigned to each transaction routed on the bus to indicate if the token or transaction ID is pending, completed, has priority, and so on. Each node uses a destination address for each transaction routed on the bus to either route the transaction to the processor assigned to its node if the destination address matches the address of the assigned processor, or pass the transaction to a neighboring node if the destination address does not match the address of the assigned processor. In some cases at least one of interconnect ring busses 206-1 and 206-2 is non-stallable, so that once traffic enters an interconnect ring bus, it proceeds to its destination. In at least some implementations, arbitration at a node such as node 215-k includes a mechanism for transaction collisions from traffic arriving simultaneously at a destination from opposite directions, the mechanism resulting in at least one transaction having to traverse a ring bus by going around it an additional time, thus preventing the collision.

Node 215-k also comprises bridges 307-1-307-2. Each bridge among bridges 307-1-307-2 is configured to transfer data on each I/O port among I/O ports 309-1-309-4 using connection mesh 310-1-310-2. For example, connection mesh 310-1-310-2 may include any suitable trace, wire bond, connection, and the like to enable data transfer between bridges 307-1-307-2 and I/O ports 309-1-309-4. Furthermore, bridges 307-1-307-2 enable data transfer to and from processor 210-k in environment 300. Here, “k” may be any integer, such as an integer between 1 and M. For example, processor 210-k may be any processor from among processors 210-1-210-M.

Processor 210-k comprise interconnect ports 312-1-312-2. Interconnect ports 312-1-312-2 enable data transfer to/from memories and/or processor assets that are mapped with unique address ranges and associated with processor 310-k. For example, interconnect ports 312-1-312-2 may enable data transfer to/from any memory from among memories 112-1-112-N in FIG. 1. Data may be transferred on interconnect ring busses 206-1-206-2 to/from a memory using interconnect ports 312-1-312-2, bridges 307-1-307-2, and I/O ports 309-1-309-4.

Interconnect port 312-1 is coupled to bridge 307-1 through interfaces 316-1 and 316-2, and interconnect port 312-2 is coupled to bridge 307-2 through interfaces 314-1 and 314-2. Interfaces 314-1 and 316-1 may comprise “write” channels, and interfaces 314-2 and 316-2 may comprise “read” channels. Each of interfaces 314-1-314-2 and 316-1-316-2 may comprise a single channel or a plurality of channels. For example, interfaces 314-1 and 316-1 may include a single channel for address writing and data requests, or separate channels, one for address writing and one for data requests. In some implementations, at least one processor transfers data to/from a node over an interface that comprises a number of read channels and/or a number of write channels that is different from a number of read channels and/or number of write channels of an interface to transfer data between a node and a processor other than the at least one processor.

Additionally, in some implementations bridges 307-1-307-2 and/or interconnect ports 312-1-312-2 conform to a standard or an open standard bus interconnect protocol, such as AXI, PCI, or 12C. Furthermore, it is to be understood that though FIG. 2 illustrates bridges 207-1-207-2 and interconnect ports 212-1-212-2 with two bridges and interconnect ports, respectively, bridges 207-1-207-2 and interconnect ports 512-1-512-2 may comprise an arbitrary number of bridges and interconnect ports, respectively.

In some implementations, modem 200 is implemented using a plurality of processors that supports a family of stock keeping units (SKU's) by including and/or activating a processor solely when the processor is to be used for one SKU among the family of SKU's. For example, a processor among the plurality of processors may be rendered inoperable so as to cause at least one feature of the device to be disabled. Furthermore, a new SKU's may be added to a family of SKU's, as new processors may be added to modem 200 using a dual, bi-directional interconnect ring bus as described in FIGS. 2 and 3. A dual, bi-directional interconnect ring bus as described in FIGS. 2 and 3 is scalable, being able to support any number of nodes and processors, yet with distributed memory support. For example, node 215-k may be a generic node that may be copied and instantiated to support modems in a family of SKU's requiring varied processor support. Furthermore, adding a processor and node to modem 200 may not increase routing congestion of existing processors and nodes, or require re-verification of existing processors.

To illustrate these concepts, processor 210-3 and node 215-3 in FIG. 2 are shown as shaded, to denote that processor 210-3 and node 215-3 may be rendered inoperable for a particular SKU, but included for another SKU. For example, a particular SKU may use processors 210-1, 210-2, and 210-M in FIG. 2, while another SKU uses processors 210-1, 210-2, 210-M together with processor 210-3. Both SKU's can be accommodated with a same chip by selectively rendering processor 210-3 inoperable. Furthermore, node 215-3 may be a copy of another node in FIG. 2, and instantiated to support processor 210-3 for a particular SKU.

For example, node 215-3 may be a generic node added together with processor 210-3 to an existing chip supporting a particular SKU to create a new chip for another SKU. The addition of node 215-3 and processor 210-3 to create the new chip may not require reworking existing processors or nodes on the existing chip due to the dual-interconnect ring-bus architecture.

Having described processors and interconnections of the processors comprising a modem device in which various embodiments can be utilized, consider now a discussion of supplying system clocks to the processors connected with a dual interconnect ring bus in accordance with one or more embodiments. The dual interconnect ring bus allows for relaxed clock tree requirements.

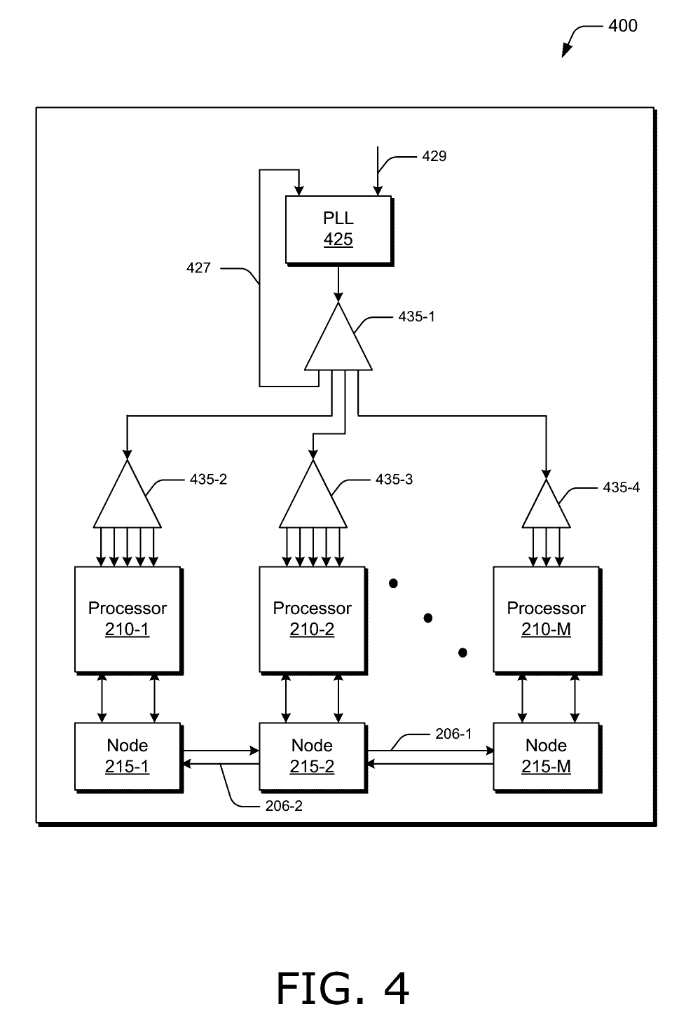

FIG. 4 shows environment 400 usable to implement at least part of modem 200 in FIG. 2. Environment 400 comprises processors 210-1-210-M paired with nodes 215-1-215-M and a clock tree comprising reference signal 429, phase locked loop (PLL) 425, feedback signal 427, and clock distribution circuits 435-1-435-4. While four clock distribution circuits 435-1-435-4 are illustrated, any number of clock distribution circuits 435-1-435-4 may include the clock tree in environment 400. In some implementations, clock tree includes reference signal 429, phase locked loop (PLL) 425, feedback signal 427, and clock distribution circuits 435-1-435-4 comprise analog RF circuitry 102 in FIG. 1. PLL 425 generates at least one clock signal using reference signal 429 and feedback signal 427. The at least one clock signal may be divided, multiplied, and/or distributed by clock distribution circuit 435-1. Clock distribution circuits 435-1-435-4 may also insert delays to the clock signals, and distribute the clock signals to processors 210-1-210-M. The distributed clock signals are used by the processors to execute instructions at a rate determined by the distributed clock signals.

Environment 400 may implement modem 200 with an unbalanced clock tree by relaxing a requirement that clock distribution circuits across all processors or clusters of processors be balanced. In FIG. 4, distribution circuit 435-2 and distribution circuit 435-3 supply clocks to processors 210-1 and 210-2, respectively, and distribution circuit 435-4 supplies clocks to processor 210-M. Distribution circuits 435-2 and 435-3 are illustrated as larger than, and with more outputs than distribution circuit 435-4 to indicate that distribution circuit 435-4 may have less latency than distribution circuits 435-2 and 435-3. Therefore latency from PLL 425 to processor 210-M is less than the latencies from PLL 425 to processors 210-1 and 210-2. A mismatch in latencies from PLL to processors is possible provided that timing between adjacent nodes is met. If a processor can provide signals from its assigned node to an adjacent node early enough for a processor assigned to the adjacent node to process the signals, then the clock tree to the processors may be imbalanced.

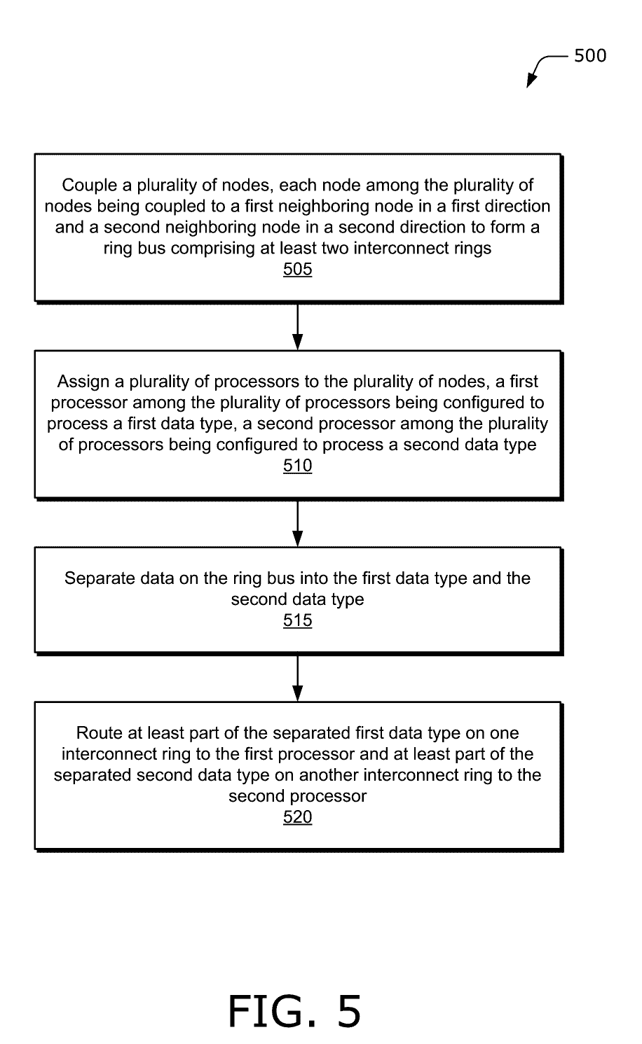

FIG. 5 illustrates example operations 500 for routing data on a dual interconnect ring bus in accordance with certain aspects of the present disclosure. Operations 505-520 may be performed at a modem in a user device, such as modem 200 in FIG. 2. The specific order or hierarchy of operations in FIG. 5 is merely an illustration of one example The specific order or hierarchy of operations may be re-arranged, amended, and/or modified without departing from the scope of the claimed subject matter.

At 505, a plurality of nodes are coupled. For example, the plurality of nodes may be nodes 215-1-215-M in FIG. 2. Each node among the plurality of nodes is coupled to a first neighboring node in a first direction and a second neighboring node in a second direction to form a ring bus comprising at least two interconnect rings. For example, the at least two interconnect rings may include interconnect ring busses 206-1 and 206-2 in FIG. 2. The at least two interconnect rings include an interconnect ring configured to route data in the first direction, and another interconnect ring configured to route data in the second direction. For example, an interconnect ring may route data in a clockwise direction, and another interconnect ring may route data in a counter-clockwise direction. Alternatively at least two interconnect rings may route data in a same direction, such as clockwise or counter-clockwise. Furthermore, the at least two interconnect rings may include an interconnect ring configured to route a first data type, data structure, data width, data rate, data packet length, and/or data format, and a second interconnect ring configured to route a second data type, data structure, data width, data rate, data packet length, and/or data format. Additionally, the plurality of nodes may each be assigned unique ID's.

At 510, a plurality of processors are assigned to the plurality of nodes. For example, the plurality of processors may be processors 210-1-210-M in FIG. 2. A first processor among the plurality of processors may be configured to process a first data type. A second processor among the plurality of processors may be configured to process a second data type. For example, the first processor may be a scalar processor, and the second processor may be a vector processor. A processor may be configured to process more than one type of data. For example, a processor may be configured to process both the first data type and the second data type, such as both scalar and vector data. Alternatively, a processor may be configured to process the first data type without being configured to process the second data type. In an embodiment, at least two processors among the plurality of processors can process a plurality of same data types, such as two processors both being able to process scalar data and vector data.

At 515, data on the ring bus is separated into the first data type and the second data type. The first and second data types may comprise a data structure, data width, data rate, data packet length, and/or data format. A data structure, data width, data rate, data packet length, and/or data format comprising the first data type may be different than a data structure, data width, data rate, data packet length, and/or data format comprising the second data type, respectively, so that the first data type is different than the second data type. Alternatively, the first data type and the second type may be comprised of a same data structure, data width, data rate, data packet length, and/or data format, so that the first data type is the same as the second data type.

At 520, at least part of the separated first data type is routed on one interconnect ring to the first processor and at least part of the separated second data type is routed on another interconnect ring to the second processor. Data may be routed in a direction determined at least in part from a minimum distance and/or minimum number of node hops around the ring bus. A direction may be determined from among a clockwise direction and a counter-clockwise direction. The one interconnect ring and/or the another interconnect ring are selectable to route data based at least in part on a minimum distance calculation and/or a determination of a minimum number of node hops around the ring bus. The separated first data type may include scalar data, and the separated second data type may include vector data. Arbitration of routed data may be done at the plurality of nodes. Routed data may be routed to a destination, such as a processor, using at least in part a unique ID assigned to a node.

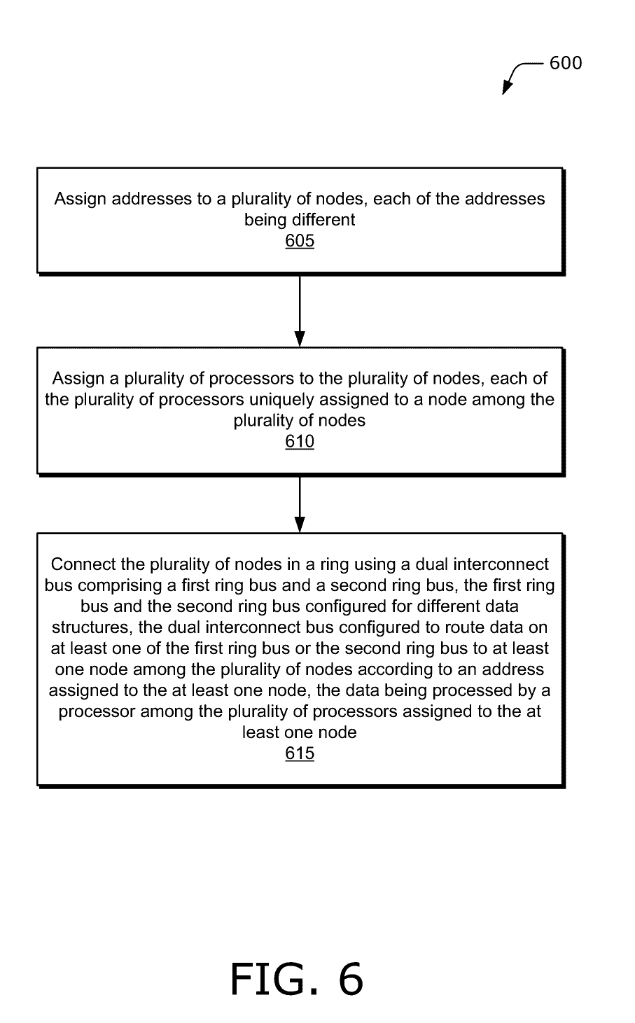

FIG. 6 illustrates example operations 600 for routing data on a ring bus comprising a first ring bus and a second ring bus in accordance with certain aspects of the present disclosure. Operations 605-615 may be performed at a modem in a user device, such as modem 200 in FIG. 2. The specific order or hierarchy of operations in FIG. 6 is merely an illustration of one example The specific order or hierarchy of operations may be re-arranged, amended, and/or modified without departing from the scope of the claimed subject matter.

At 605, addresses are assigned to a plurality of nodes. For example, the plurality of nodes may be nodes 215-1-215-M in FIG. 2. Each of the addresses may be different. For example, an address for one node among the plurality of nodes may be different than an address for a node other than the one node. Hence, each node among the plurality of nodes may be uniquely identified using the addresses assigned to the plurality of nodes.

At 610, a plurality of processors are assigned to the plurality of nodes. For example, the plurality of processors may be processors 210-1-210-M in FIG. 2. Each of the plurality of processors may be uniquely assigned to a node among the plurality of nodes. For example, a node assigned for one processor among the plurality of processors may be different than a node assigned for a processor other than the one processor.

At 615, the plurality of nodes are connected in a ring using a dual interconnect bus comprising a first ring bus and a second ring bus. For example, the first and second ring busses may include interconnect ring busses 206-1 and 206-2 in FIG. 2. The first ring bus and the second ring bus may be configured for different data structures. The dual interconnect bus may be configured to route data on at least one of the first ring bus or the second ring bus to at least one node among the plurality of nodes according to an address assigned to the at least one node. The routed data may be processed by a processor among the plurality of processors assigned to the at least one node. A data structure may comprise a data type, data width, data rate, data packet length, and/or data format, and the like.

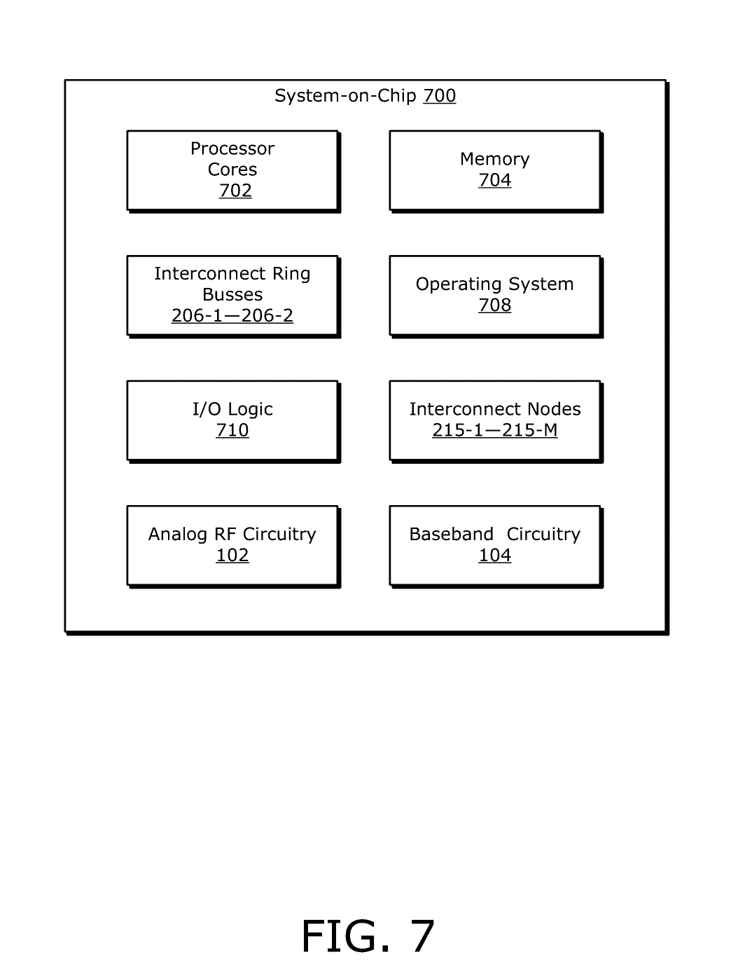

FIG. 7 illustrates an example system-on-chip (SoC) 700, which includes components capable of implementing aspects of routing data to processors on a dual interconnect ring bus. System-on-chip 700 may be implemented as, or in, any suitable electronic device, such as a modem, broadband router, access point, cellular phone, smart-phone, gaming device, laptop computer, net book, set-top-box, smart-phone, network-attached storage (NAS) device, cell tower, satellite, cable head-end, and/or any other device that may route data among processors.

System-on-chip 700 may be integrated with a microprocessor, storage media, I/O logic, data interfaces, logic gates, a transmitter, a receiver, circuitry, firmware, software, and/or combinations thereof to provide communicative or processing functionalities. System-on-chip 700 may include a data bus (e.g., cross bar or interconnect fabric) enabling communication between the various components of the system-on-chip. In some aspects, components of system-on-chip 700 may interact via the data bus to implement aspects of data routing on a dual interconnect ring bus.

In this particular example, system-on-chip 700 includes processor cores 702 and memory 704. Memory 704 may include any suitable type of memory, such as volatile memory (e.g., DRAM), non-volatile memory (e.g., flash), cache, and the like. For example, memory 704 may comprise memories 112-1-112-N in FIG. 1. In the context of this disclosure, memory 704 is implemented as a storage medium, and does not include transitory propagating signals or carrier waves. Memory 704 can store data and processor-executable instructions of system-on-chip 700, such as operating system 708 and other applications. Processor cores 702 may execute operating system 708 and other applications from memory 704 to implement functions of system-on-chip 700, the data of which may be stored to memory 706 for future access. For example, processor cores may comprise baseband processors 110-1-110-N in FIG. 1, and implement modem functions. System-on-chip 700 may also include I/O logic 710, which can be configured to provide a variety of I/O ports or data interfaces for off-chip communication.

System-on-chip 700 also includes interconnect ring busses 206-1-206-2 and interconnect nodes 215-1-216-M which may be configured as a dual interconnect ring bus as illustrated in FIG. 2 and FIG. 3 to route data among processors connected to the interconnect nodes 215-1-215-M. For example, processors comprising processor cores 702 may be connected to interconnect nodes 215-1-215-M using interconnect ring busses 206-1-206-2 to form a bi-directional, dual interconnect ring that routes data to the processors to implement functions of a modem.

System-on-chip 700 also includes analog RF circuitry 102 and baseband circuitry 104, which may be embodied separately or combined with other components described herein. For example, baseband circuitry 104 may be connected to interconnect ring busses 206-1-206-2 via a node, such as nodes 215-1-215-M, to implement functions of a modem concurrently or in combination with processors comprising processor cores 702. Alternately or additionally, baseband circuitry 104 and the other components can be implemented as hardware, firmware, fixed logic circuitry, or any combination thereof that is implemented in connection with interconnect ring busses 206-1-206-2 and/or other signal processing and control circuits of system-on-chip 700.

In one or more exemplary embodiments, the functions described may be implemented in hardware, software, firmware, or any combination thereof. If implemented in software, functions may be stored on a computer-readable storage medium (CRM). In the context of this disclosure, a computer-readable storage medium may be any available medium that can be accessed by a general-purpose or special-purpose computer that does not include transitory propagating signals or carrier waves. By way of example, and not limitation, such media can comprise RAM, ROM, EEPROM, CD-ROM or other optical disk storage, magnetic disk storage, or other magnetic storage devices, or any other non-transitory medium that can be used to carry or store information that can be accessed by a general-purpose or special-purpose computer, or a general-purpose or special-purpose processor. The information can include any suitable type of data, such as computer readable instructions, sampled signal values, data structures, program components, or other data. These examples, and any combination of storage media and/or memory devices, are intended to fit within the scope of non-transitory computer-readable media. Disk and disc, as used herein, includes compact disc (CD), laser disc, optical disc, digital versatile disc (DVD), floppy disk and Blu-ray disc where disks usually reproduce data magnetically, while discs reproduce data optically with a laser. Combinations of the above should also be included within the scope of computer-readable media.

Firmware components include electronic components with programmable memory configured to store executable instructions that direct the electronic component how to operate. In some cases, the executable instructions stored on the electronic component are permanent, while in other cases, the executable instructions can be updated and/or altered. At times, firmware components can be used in combination with hardware components and/or software components.

The term “component”, “module”, and “system” are indented to refer to one or more computer related entities, such as hardware, firmware, software, or any combination thereof, as further described above. At times, a component may refer to a process and/or thread of execution that is defined by processor-executable instructions. Alternately or additionally, a component may refer to various electronic and/or hardware entities.

Certain specific embodiments are described above for instructional purposes, the teachings of this disclosure have general applicability, however, and are not limited to the specific embodiments described above. The bi-directional, dual interconnect ring bus is not limited to use in realizing modems that communicate in accordance with any particular interface standard such as LTE, UMB, or WiMAX, but rather the bi-directional, dual interconnect ring bus has general applicability to other interface standards.

What is claimed is:

1. A device for processing signals, the device comprising:
a plurality of nodes, each node having an address that is unique;
a plurality of processors, each processor uniquely assigned to a respective node of the plurality of nodes; and
an interconnect bus having at least a first ring bus and a second ring bus, the interconnect bus configured to:
connect the plurality of nodes in a ring; and
route data on at least one of the first ring bus or the second ring bus determined from a data type of the data to a node of the plurality of nodes according to the address assigned to the node, the data processed by the processor of the plurality of processors that is uniquely assigned to the node.

2. The device of claim 1, wherein the plurality of processors includes at least one scalar processor and at least one vector processor.

3. The device of claim 1, wherein the dual interconnect bus is configured to separate the data into a first data type and a second data type, in which the first data type is to be routed on the first ring bus and the second data type is to be routed on the second ring bus.

4. The device of claim 1, wherein the first ring bus is configured to route data in a first direction and the second ring bus is configured to route data in a second direction different than the first direction.

5. The device of claim 1, wherein the data is routed in a direction determined by the address assigned to the node of the plurality of nodes.

6. The device of claim 5, wherein the direction is determined at least in part on a calculation of a number of node hops.

7. The device of claim 1, wherein the processed signals comprise a first signal that complies with a first regulatory standard and a second signal that complies with a second regulatory standard.

8. The device of claim 1, wherein at least one of the plurality of processors is configured to be rendered inoperable so as to cause at least one corresponding feature to be disabled.

9. A method for routing data on a ring bus, the method comprising:
separating data on the ring bus into a first data type and a second data type, the ring bus being formed by coupling each node of a plurality of nodes to a first neighboring said node in a first direction and a second neighboring said node in a second direction, the plurality of nodes being assigned a plurality of processors; and
routing at least part of the separated data of the first data type on one of the at least two interconnect rings to a first processor configured to process the first data type and at least part of the separated data of the second data type on another one of the at least two interconnect rings to a second processor configured to process the second data type.

10. The method of claim 9, wherein the separated data of the first data type includes scalar data and the separated data of the second data type includes vector data.

11. The method of claim 9, wherein at least part of the separated data of the first data type or the separated data of the second data type is routed in a direction based on a number of node hops.

12. The method of claim 9, wherein the routing comprises assigning a transaction ID.

13. The method of claim 9, wherein at least one of the at least two interconnect rings is non-stallable effective to cause the routed data to stay on the at least one of the at least two interconnect rings until the routed data reaches its destination.

14. The method of claim 9, wherein the plurality of nodes perform data arbitration.

15. The method of claim 14, wherein the data arbitration includes routing collided data around at least one of the at least two interconnect rings an additional time.

16. An apparatus for processing signals, the apparatus comprising:
a plurality of nodes, each node of the plurality of nodes having an address that is different;
a plurality of processors;
a ring bus comprising at least two interconnect rings;
means for, based on the addresses, assigning the plurality of processors to the plurality of nodes in which a first processor among the plurality of processors is configured to process a first data structure and a second processor among the plurality of processors is configured to process a second data structure;
means for, based on the addresses, coupling the plurality of nodes to the ring bus such that each node of the plurality of nodes is coupled to a first neighboring node in a first direction and a second neighboring node in a second direction;
means for, based on the first data structure and the second data structure, separating data on the ring bus; and
means for, based on the separated data, routing at least part of the separated data on one of the at least two interconnect rings to the first processor and at least another part of the separated data on another one of the at least two interconnect rings to the second processor.

17. The apparatus of claim 16, wherein at least one processor of the plurality of processors is configured to transfer data with the ring bus at a rate different from a rate at which another processor transfers data with the ring bus.

18. The apparatus of claim 16, wherein at least part of the separated data is routed in the first direction or the second direction, the routing determined based on a number of node hops.

19. The apparatus of claim 16, wherein at least one processor of the plurality of processors is clocked from a clock tree with a first latency different from a second latency at which another processor of the plurality of processors is clocked from the clock tree.

20. The apparatus of claim 16, wherein the plurality of nodes are configured to perform data arbitration.

21. The apparatus of claim 20, wherein the data arbitration includes routing collided data around at least one of the at least two interconnect rings an additional time.

22. A method for processing signals, the method comprising:
assigning a plurality of addresses to a plurality of nodes, each node of the plurality of nodes having an assigned address that is different;
assigning a plurality of processors to the plurality of nodes so that each of the plurality of processors is uniquely assigned to a respective node of the plurality of nodes;
connecting a first ring bus and a second ring bus to the plurality of nodes in a ring, the first ring bus and the second ring bus being configured for different data structures;
routing data on at least one of the first ring bus or the second ring bus determined from a data type of the data to a node of the plurality of nodes according to the address assigned to the node; and
processing the data with the processor of the plurality of processors that is uniquely assigned to the node of the plurality of nodes.

23. The method of claim 22, wherein the plurality of processors includes at least one scalar processor and at least one vector processor.

24. The method of claim 22, wherein the routing includes separating the data into a first data type and a second data type and routing the first data type on the first ring bus and the second data type on the second ring bus.

25. The method of claim 22, wherein the routing includes routing the data on the first ring bus in a first direction and routing the data on the second ring bus in a second direction different than the first direction.

26. The method of claim 22, wherein the routing includes routing the data in a direction determined by the address assigned to the node of the plurality of nodes.

27. The method of claim 26, wherein the direction is determined at least in part on a calculation of a number of node hops.

28. The method of claim 22, wherein the routing includes routing the data so it stays on the first ring bus or the second ring bus until the data reaches its destination.

29. The method of claim 22, wherein at least one of the plurality of processors is configured to be rendered inoperable effective to disable a corresponding feature.

30. The method of claim 22, wherein at least one of the plurality of processors is clocked from a clock tree with a first latency different from a second latency at which another processor of the plurality of processors is clocked from the clock tree.
